(19) United States
(12) Patent Application Publication
(10) Pub. No.: US 2014/0008427 A1
(43) Pub. Date: Jan. 9, 2014

(54) APPARATUS FOR RETRIEVING DATA FROM MULTIPLE MEDIA AND METHOD OF THE SAME

(71) Applicant: DATA LTD., INC., LaPorte, IN (US)

(72) Inventor: Bryan J. WESOLEK, LaPorte, IN (US)

(21) Appl. No.: 13/931,364

(22) Filed: Jun. 28, 2013

Related U.S. Application Data
(60) Provisional application No. 61/667,866, filed on Jul. 3, 2012.

(51) Int. Cl. G06F 17/30

(52) U.S. Cl. CPC G06F 17/30
USPC 235/375; 340/10.1

(57) ABSTRACT

A method and apparatus for retrieving data and personal identification information from multiple media types in which data is received by an affixed module, is transferred to the operating system, interpreted by a Service Object and delivered to an application as the native form of the medium or to be interpreted by the application as the same or other medium without knowledge of the origin of the data medium.

### TECHNICAL FIELD

The present invention relates to an apparatus and a method for retrieving data from different media and processing said data. In particular, the present invention relates to an apparatus and method which allow any amount of different media types to be all concurrently retrievable.

### RELATED ART

In prior art, devices which are used to retrieve data and transfer said data into a computer which is used to process the data, merely report standard information amongst the media. For example, a magnetic swipe reader which retrieves magnetic card formatted data only transfers magnetic card formatted data to the computer (mobile or otherwise).

The present invention allows multiple media (such as magnetic cards, radio-frequency identification (RFID) tags, smart cards) to be interchangeably transmitted to an application on the computer. In such way, the application requires no extra processing to read the data as another medium. For example, an RFID tag can be read by an RFID reader, and the subject invention presents the read data to the application as if a magnetic card had been read. Such allowance provides users, code writers, and project managers with maximum flexibility in what is required for their personal identification, how data can be stored and read, and how efficiency can be gained by removing media limitations.

In other words, the subject invention provides the flexibility for an application developer to read the various media without coding them to set media types. For example, this would mean an application may be written exclusively to retrieve magnetic card data; however using the subject invention, other media will be usable by the application intended for receipt of magnetic card data.

### SUMMARY OF THE INVENTION

The subject invention presents an apparatus and a method for retrieving data in such a way that multiple media may be used and transmitted to an application as interchangeable forms of data.

An aspect of the present invention discloses a method for retrieving data, the method comprising: receiving input data from one of the media by one of input peripheral units; interpreting the input data into output data by a service object (SO), wherein the output data is in a format that complies with a desired medium; and transferring the output data to an application for further utilization.

Another aspect of the present invention discloses a module for retrieving data, the module comprising: a multiple media printed circuit board; and a plurality of input peripheral units electrically coupled to the multiple media printed circuit board; wherein input data is received from one of the media by one of the input peripheral units and transferred to the multiple media printed circuit board.

A further aspect of the present invention discloses an apparatus for processing data, the apparatus comprising: the module stated above; a device electrically coupled with the multiple media printed circuit board of the module through communication connection, the device comprising: a service object (SO) receiving the input data from the multiple media printed circuit board of the module, and interpreting the input data into output data, wherein the output data is in a format that complies with a desired medium; and an application receiving the output data for further utilization.

### BRIEF DESCRIPTION OF THE DRAWINGS

The present invention is best described in terms of the following figures:

FIG. 1 is a block diagram of a typical embodiment of the subject invention describing the flow of data being transferred from the media (meaning magnetic card, radio frequency tag, user input, smart card, barcode, or user signature) and the order in which it is transferred to the multiple media printed circuit board (PCB) and subsequently to the application;

FIG. 2 is another block diagram of a typical embodiment of the subject invention describing how data from one data source is received to the service object (firmware, dynamic link library, or java native interface) and is converted to magnetic card, barcode, radio frequency identification, smart card, pinpad or signature data;

FIG. 3 is a flow chart of a typical embodiment of the subject invention describing a transaction whereby the subject invention is configured to interpret smart card data as barcode data;

FIG. 4 is another flow chart of a typical embodiment of the subject invention describing a transaction when focusing on the relationship between the SO and the processed data whereby the subject invention is configured to interpret smart card data as barcode data;

FIG. 5 is another flow chart of a typical embodiment of the subject invention describing a transaction when observing from the perspective of application whereby the subject invention is configured to interpret smart card data as barcode data;

FIGS. 6A-8C are schematic diagrams displaying the physical characteristic of the module and are meant to display multiple means of affixation as examples of the method of affixation regarding mobile computers; this indicates that the cabled, non-cabled, and wireless methods are irrelevant since the connection is from the PCB to the motherboard of the mobile computer; and

FIGS. 9A-10C are schematic diagrams displaying the physical characteristics of the module and are meant to display multiple means of affixation as examples of the method of affixation regarding handheld computers; this indicates that the cabled, non-cabled, and sled accessory are irrelevant as connections of a handheld computer.

### DETAILED DESCRIPTION OF THE PREFERRED EMBODIMENTS

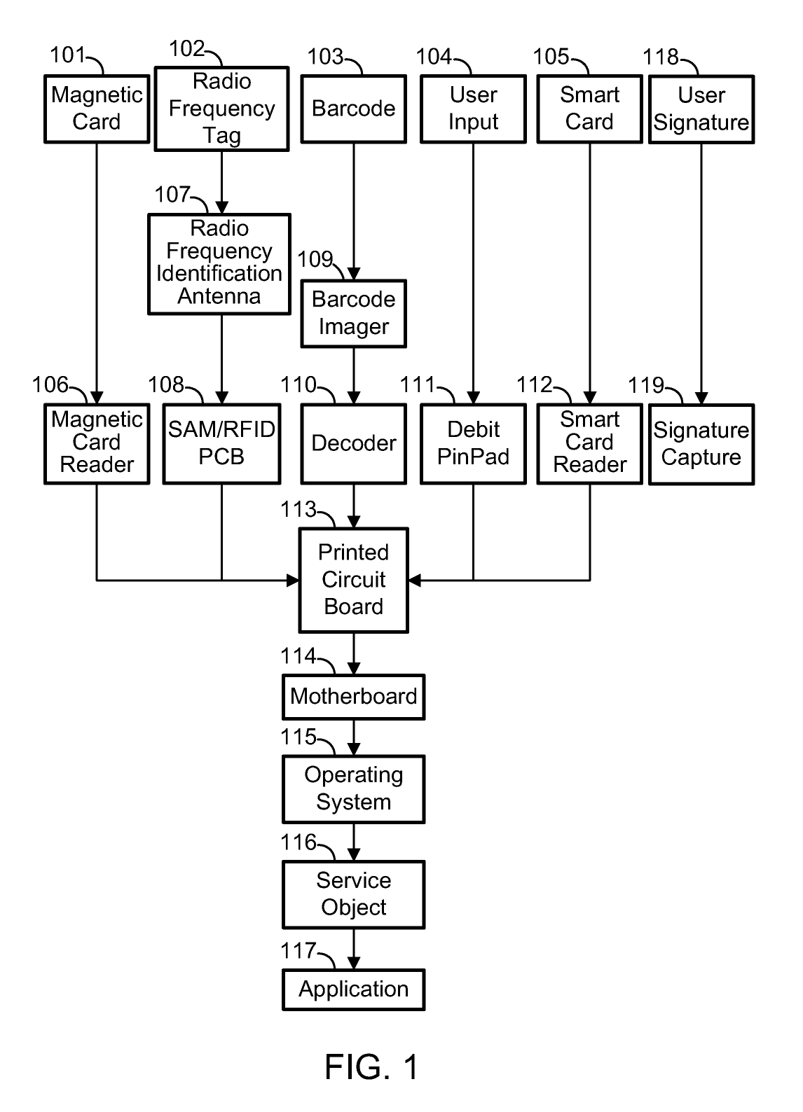

FIG. 1 is a block diagram showing the data flow of a data retrieving apparatus 1 according to an embodiment of the subject invention. The apparatus of the present invention includes a module and a device electrically coupled with the module.

The module comprises a plurality of input peripheral units, such as a magnetic car reader 106, a radio frequency identification (RFID) antenna 107, a secure access module (SAM)/RFID PCB 108, a barcode imager 109, a decoder 110, a debit pinpad 111, a smart card reader 112 and a signature capture interface 119. These input peripheral units 106, 107, 108, 109, 110, 111, 112, and 119, are built on a multiple media printed circuit board (PCB) 113. In some embodiments, the input peripheral units 106, 107, 108, 109, 110, 111, 112, and 119 and PCB 113 are housed in a housing of the module.

Magnetic card 101, radio frequency tag 102, barcode 103, user input 104, and smart card 105 are the various data media. When inputting data, the magnetic card 101 is swiped though the magnetic card reader 106 to read the data stored in magnetic card 101. Similarly, the data in the radio frequency tag 102 is received by radio frequency identification (RFID) antenna 107 through bringing the radio frequency tag 102 into proximity of the RFID antenna 107, wherein the RFID antenna 107 is built on the security authentication module (SAM)/RFIDPCB 108. It should be noted here that the type of RFID is not specific and may include NFC or Bluetooth and should be interpreted as the broadest definition of RFID. The barcode 103 is visually photographed by the barcode imager 109 and interpreted by the decoder 110 to get the information recorded in the barcode 103. It should be noted here that the type of barcode is not specific and may include QR Code, Code-39, Code-128, among any other type of barcode standard. The user input 104 is considered any user which is capable of manual entry of a keypad. Namely, the user input 104 is entered by a user pressing the keys on the debit pinpad 111. The smart card 105 contains a microchip which stores its data and this data is transferred via electrical contact of the smart card reader 112 to transfer data.

The device is preferably a mobile computer, a tablet computer, a PDA (personal digital assistant) or a smart phone. In the current embodiment, the device comprises a motherboard 114, employs an operating system 115, a service object (SO) 116 and an application 117. The motherboard 114 of the device is electrically coupled with the printed circuit broad (PCB) 113 of the module through communication connection, which can be at least one of communication (COM) port, peripheral component interconnect (PCI), universal serial bus (USB), Firewire, RS-232, Bluetooth, IEEE 820.11, Infrared data link, and Ethernet.

Once data (e.g., purchase, item, personal identification information) input from any medium 101, 102, 103, 104, 105, or 118, has been retrieved by the compatible reader built on the PCB 113, the data will be transferred to the motherboard 114. The data received by the motherboard 114 will be input into the operating system 115 for further processing. The operating system (OS) 115 transforms the data into a format of an intermediate code (e.g., Binary code or ASCII code) and processes this preliminarily transformed data via dII/jn1 to the service object (SO) 116. The SO 116 manipulates the input data media and converts it to a configured output data media, wherein the SO 116 may be at least one of firmware, dynamic link library, and java native interface. The data received by the SO 116 will be transformed into the format that complies with a desired medium, and then the data transformed by the SO 116 will be processed to the application 117 for further utilization. The application 117 is software to be executed on the device.

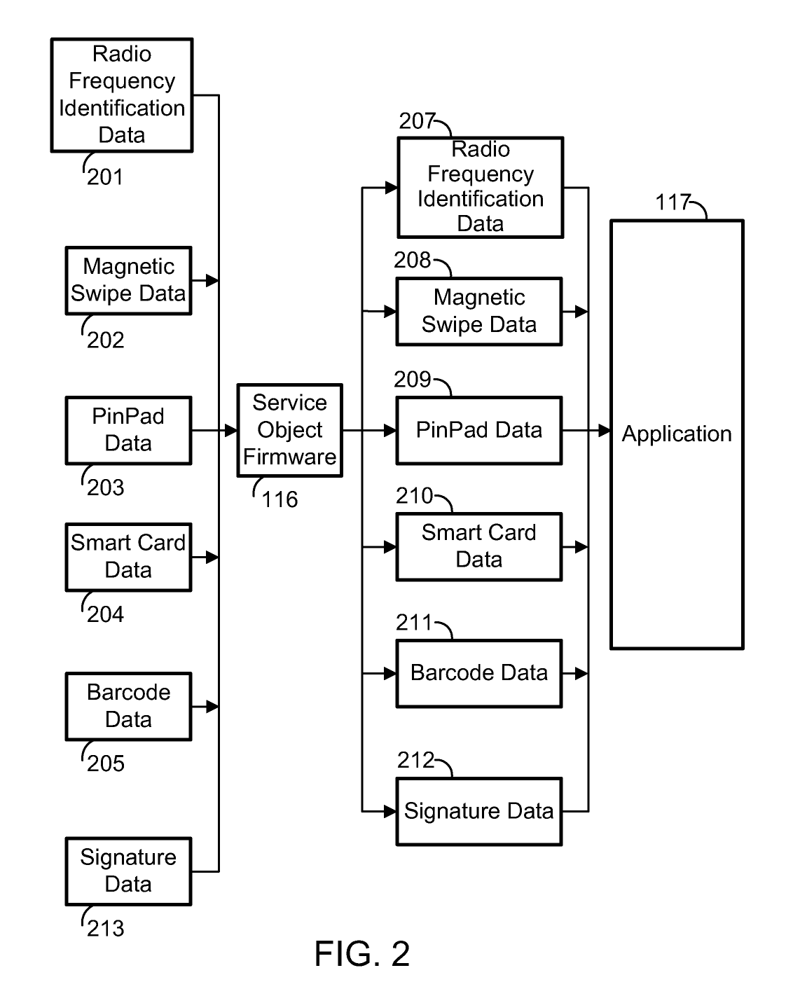

FIG. 2 depicts the relationship between the SO 116 and the processed data. Data 201, 202, 203, 204, 205, and 213 are considered as the data transferred from the OS 115. As mentioned above, the data processed by the OS 115 will be transferred to SO 116. Data 207 through 212 are the possible interpretations of the SO 116. Once the proper outcome of 207 through 212 has been determined by the SO 116 (based on the configuration), the proper interpretation will be delivered to the application 117. The application 117 will read the outcome as if the data received was actually the data scanned. For example, if the RFID tag 102 is configured with magnetic swipe data, the SO will deliver the data as magnetic swipe data 208 and the application 117 will see the data as through it was literally received through the magnetic card reader 106 or if the configured outcome of the magnetic swipe data 202 were magnetic swipe data 208.

Even though FIG. 2 shows that data 201, 202, 203, 204, 205, and 213 use the same service object, it is possible that data 201, 202, 203, 204, 205, and 213 can be divided into two or more than two groups, and that the different groups use different service objects. Further, the present invention is applicable to at least one of Object Linking and Embedding for Retail Point of Sale (OPOS), Java for Retail Point of Sale (JPOS), and iOS environments.

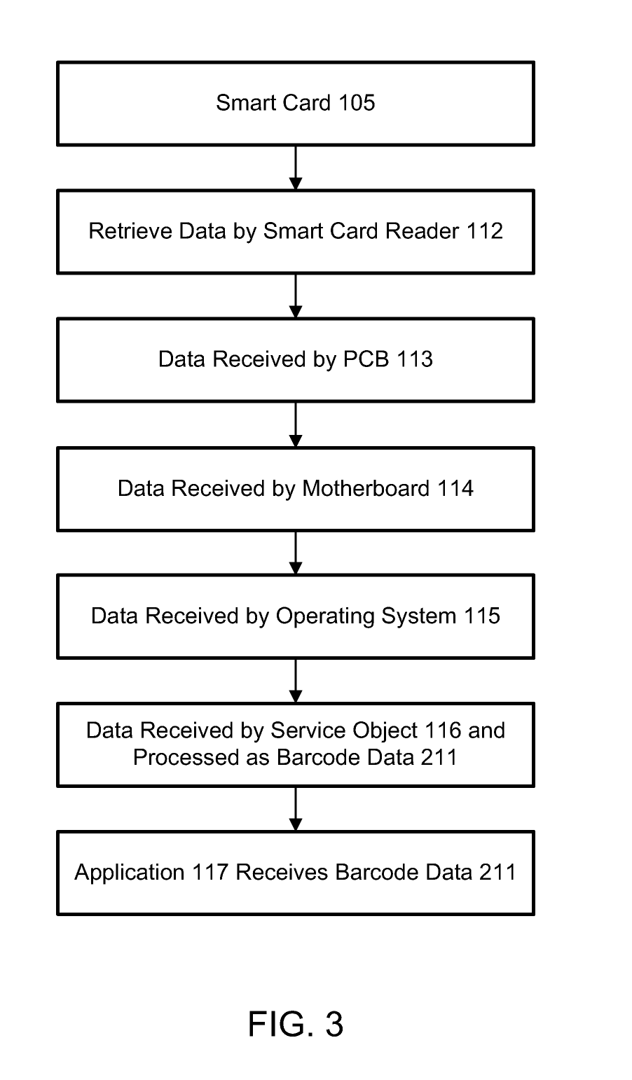

FIG. 3 discloses another example of what the interchangeability of the data provided by the SO would be. If the smart card 105 is configured with the data format of the barcode 103, the SO 116 will be configured to interpret the smart card data 204 as barcode data 211, and the path of information would be described in the following steps in terms of FIG. 1 and FIG. 2:

1. The data of smart card 105 is retrieved by the smart card reader 112;

2. The data is received by the PCB 113;

3. The data is received by the motherboard 114;

4. The data is received by the OS 115;

5. The data is received by the service object 116 and processed as the barcode data 211; and

6. The data is received by the application 117.

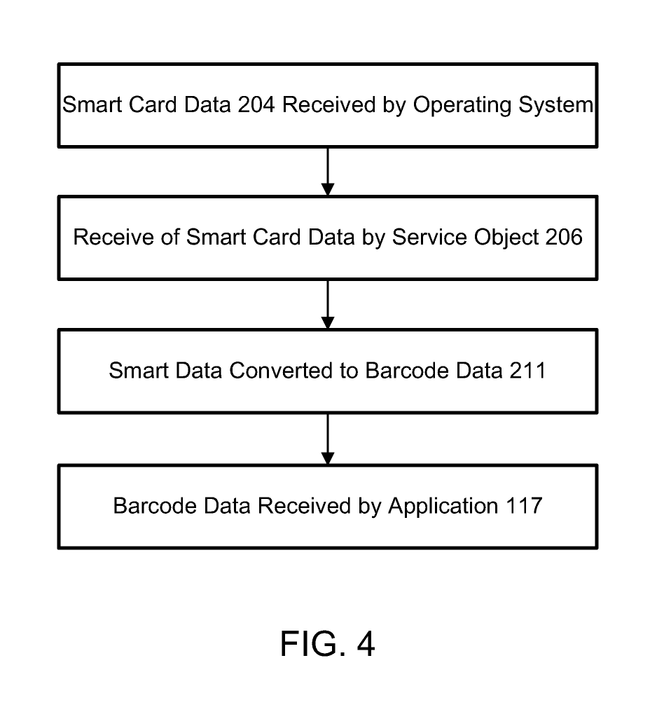

For the same example, referring to FIG. 4, which focuses on the relationship between the SO 116 and the processed data, the transaction is described as following steps in terms of FIG. 2:

1. Smart card data 204 received by the OS 115 is sent to the service object 116;

2. Smart card data 204 is received by the service object 116;

3. Smart card data 204 is converted to the barcode data 211; and

4. Barcode data is sent to the application 117.

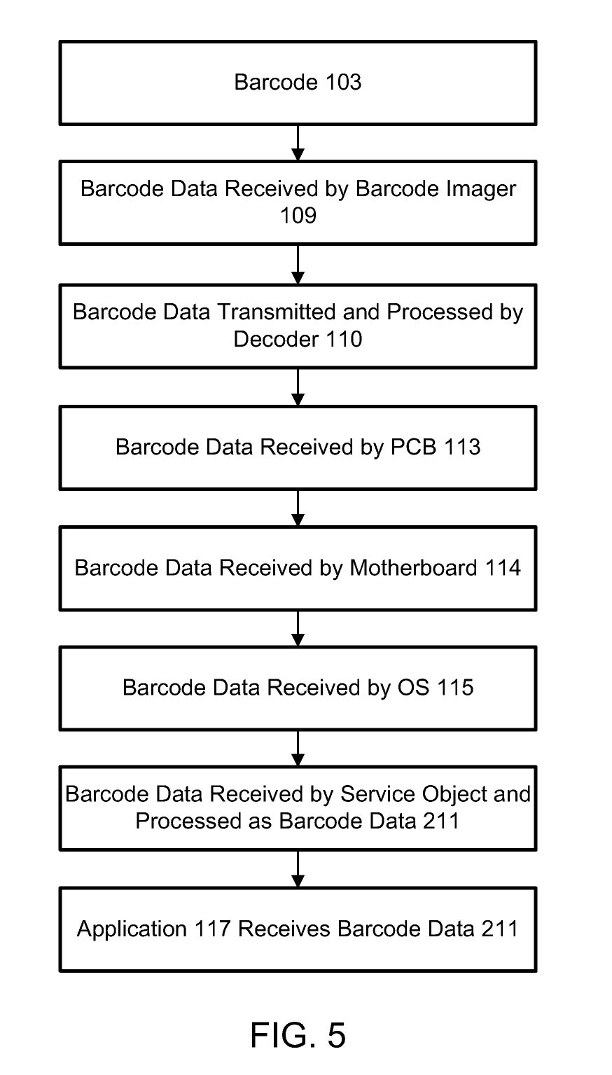

For the same example, referring to FIG. 5, when observing from the perspective of the application 117, the entire transaction will appear as follows:

1. Barcode 103 is scanned by the barcode imager 109;

2. Barcode data is processed by the decoder 110;

3. Barcode data received by the PCB 113;

4. Barcode data received by the motherboard 114;

5. Barcode data received by the OS 115;

6. Barcode data is received by the SO 116 and processed as barcode data; and

7. Barcode data is sent to the application 117.

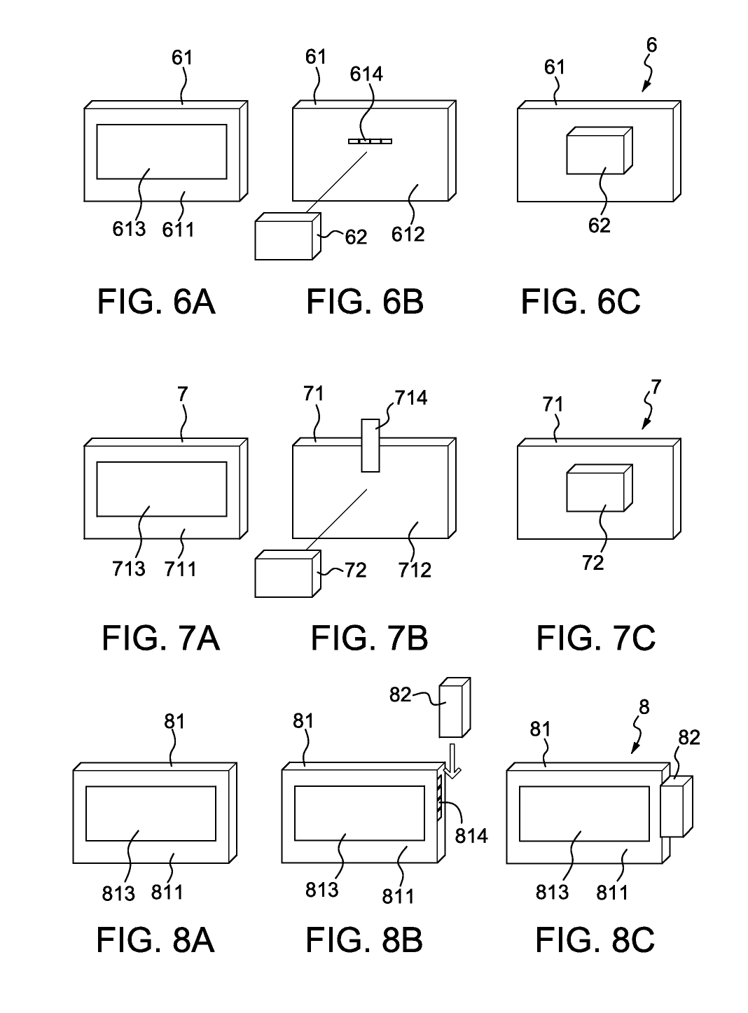

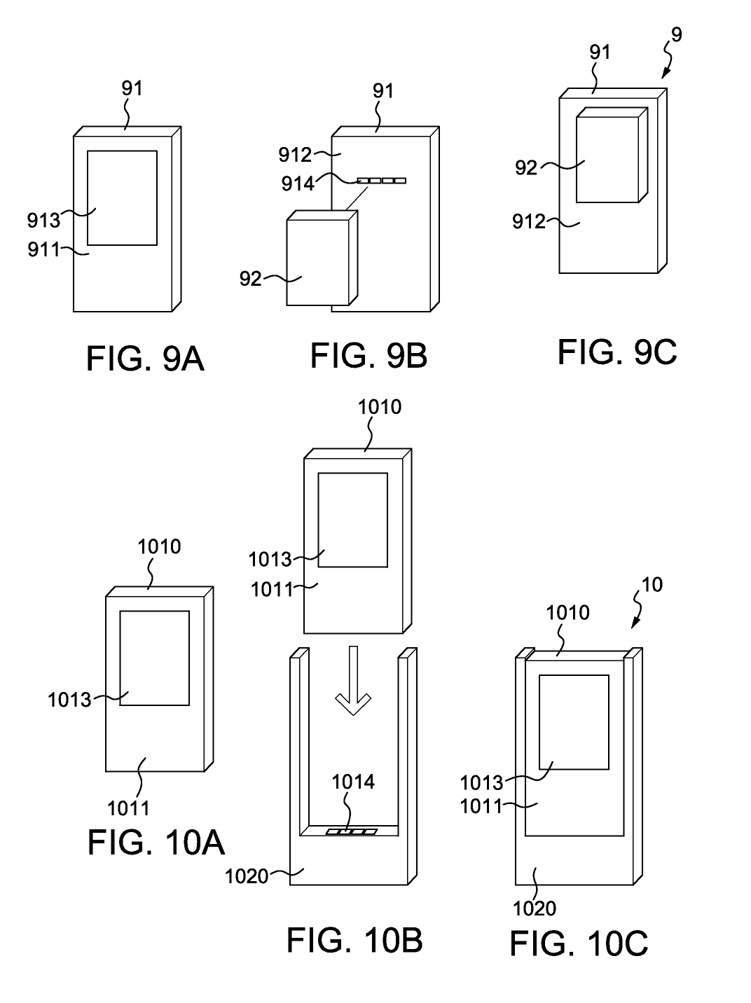

FIGS. 6 through FIG. 10 disclose the embodiments of the present invention and show how a module is affixed to a mobile device with different means.

In FIGS. 6A to 10C, the mobile and handheld computers refer to any mobile or handheld device, wherein FIGS. 6A, 7A, 8A, 9A and 10A show the front perspective view of a mobile device in different embodiments, FIGS. 6B, 7B, 8B, 9B and 10B show the affixation of a module to a rear of a mobile device in different embodiments, and FIGS. 6C, 7C, 8C, 9C and 10C show the rear perspective view of an apparatus of the present invention. Further, among FIGS. 6A to 10C, the reference numerals 61, 71, and 81 represent mobile computers, and the reference numerals 91 and 1010 represent handheld computers.

Connectors 614, 714, 814, 914 and 1014 in FIGS. 6B, 7B, 8B, 9B and 10B, respectively, are examples of different connector types which may be used for attaching at least a part of the modules 62, 72, 82, 92, and 1020. However, the connectors 614, 714, 814, 914, and 1014 are possible examples of wired connection cases, and electrically coupling at least a part of the subject invention to the mobile and handheld computer via wireless connection is possible, for example, by Bluetooth or IEEE 802.11. Modules 62, 72, 82, 92 and 1020 have corresponding connectors which affix to the connectors 614, 714, 814, 914 and 1014, wherein 614, 814, 914 and 1014 are examples of direct connections, and 714 is an example of a cable connector.

In FIGS. 6B, 7B and 9B, the affixation method of connectors 614, 714 and 914 used in a typical application is screws which affix the module 62 to the device 61; affix the module 72 to the device 71; and affix the module 92 to the device 91. Once affixed, the final products 6, 7 and 9 (i.e., the apparatus of the present invention) are considered a mobile/handheld computer capable of a receiving all media 101, 102, 103, 104 and 105, as shown in FIGS. 6C, 7C and 9C. In FIG. 8B, the affixation method of the connector 814 is considered a slide lock to affix the module 82. Once affixed, the final product 8 (i.e., the apparatus of the present invention) is considered a mobile computer capable of receiving all media 101, 102, 103, 104 and 105, as shown in FIG. 8C. In FIG. 10B, the affixation method of the connector 1014 is considered a sled to affix the module 1020. Once affixed, the final product 10 (i.e., the apparatus of the present invention) is considered a handheld computer capable of receiving all media 101, 102, 103, 104, and 105, as shown in FIG. 10C.

As disclosed previously, contained within modules 62, 72, 82, 92, and 1020 are at least one of the reading devices 106, 107, 108, 109, 110, 111 and 112 and the PCB 113. In a possible embodiment, the modules 62, 72, 82, 92 and 1020 also provide a means of transmitting data to the mother board 114 which is contained in all of devices 61, 71, 81, 91 and 1010. It should be noted that the motherboard 114 is not exclusive to devices 61, 71, 81, 91 and 1010, wherein these devices are examples of the types of devices that are capable of using the ascribed technology.

Through the detailed description for the above preferable specific embodiments, it is intended to describe the features and the spirit of the present invention more clearly and not to limit the scope of the present invention with the foregoing disclosed preferable specific embodiments. Instead, it is intended to encompass various modifications and equivalent arrangements in the scope of claims of the present invention. Therefore, the scope of claims of the present invention should be interpreted in its broadest sense according to the foregoing illustration to enable the scope to encompass all possible modifications and equivalent arrangements.

1. A method for retrieving data, the method comprising:
receiving input data from one of the media by one of input peripheral units;
interpreting the input data into output data by a service object (SO), wherein the output data is in a format that complies with a desired medium; and
transferring the output data to an application for further utilization.

2. The method as recited in claim 1, wherein the media comprise:
a magnetic card;
a radio frequency tag; and
at least one of the following:
a barcode;
a user input; and
a smart card.

3. The method as recited in claim 2, wherein the input peripheral units comprise:
a magnetic card reader for receiving the input data from the magnetic card;
a radio frequency identification (RFID) antenna and a secure access module (SAM)/RFID printed circuit board for receiving the input data from the radio frequency tag; and
at least one of the following:
a barcode imager and a decoder for receiving the input data from the barcode;
a smart card reader for receiving the input data from the smart card; and
a debit pinpad for receiving the input data from the user input.

4. The method as recited in claim 3, wherein the media further comprise a user signature and the input peripheral units further comprise a signature capture interface for receiving the input data from the user signature.

5. The method as recited in claim 4, wherein the desired medium is one of the media.

6. The method as recited in claim 5, wherein the SO comprises at least one of firmware, dynamic link library, and Java native interface.

7. The method as recited in claim 6, wherein the method is applicable to at least one of Object Linking and Embedding for Retail Point of Sale (OPOS), Java for Retail Point of Sale (JPOS), and iOS environments.

8. The method as recited in claim 7, wherein the application is software to be executed on at least one of a computer, a tablet, a PDA, and a smart phone.

9. A module for retrieving data, the module comprising:
a multiple media printed circuit board; and
a plurality of input peripheral units electrically coupled to the multiple media printed circuit board;
wherein input data is received from one of the media by one of input peripheral units and transferred to the multiple media printed circuit board.

10. An apparatus for processing data, the apparatus comprising:
A module for retrieving data, the module comprising:
a multiple media printed circuit board; and
a plurality of input peripheral units electrically coupled to the multiple media printed circuit board;
wherein input data is received from one of the media by one of input peripheral units and transferred to the multiple media printed circuit board; and a device electrically coupled with the multiple media printed circuit board of the module through communication connection, the device comprising:
a service object (SO) receiving the input data from the multiple media printed circuit board of the module, and interpreting the input data into output data, wherein the output data is in a format that complies with a desired medium; and
an application receiving the output data for further utilization.

11. The apparatus as recited in claim 10, wherein the media comprise:
a magnetic card;
a radio frequency tag; and
at least one of the following:
a barcode;
a user input; and
a smart card.

12. The apparatus as recited in claim 11, wherein the input peripheral units comprise:
a magnetic card reader for receiving the input data from the magnetic card;
a radio frequency identification (RFID) antenna and a secure access module (SAM)/RFID printed circuit board for receiving the input data from the radio frequency tag; and
at least one of the following:
a barcode imager and a decoder for receiving the input data from the barcode;
a smart card reader for receiving the input data from the smart card; and
a debit pinpad for receiving the input data from the user input.

13. The apparatus as recited in claim 12, wherein the media further comprise a user signature, and the input peripheral units further comprise a signature capture interface for receiving the input data from the user signature.

14. The apparatus as recited in claim 13, wherein the desired medium is one of the media.

15. The apparatus as recited in claim 14, wherein the SO comprises at least one of firmware, dynamic link library, and Java native interface.

16. The apparatus as recited in claim 15, wherein the communication connection comprises at least one of communication (COM) port, peripheral component interconnect (PCI), universal serial bus (USB), Firewire, RS-232, Ethernet, and Bluetooth.

17. The apparatus as recited in claim 16, wherein the device is applicable to at least one of Object Linking and Embedding for Retail Point of Sale (OPOS), Java for Retail Point of Sale (JPOS), and iOS environments.

18. The apparatus as recited in claim 17, wherein the device is at least one of a computer, a tablet, a PDA and a smart phone.

19. The apparatus as recited in claim 10, wherein the module is affixed to the device by affixation means.

20. The apparatus as recited in claim 17, wherein the affixation means is one of screws, a slide lock, a cable connector, and a sled.
